(19) United States
(12) Patent Application Publication
(10) Pub. No.: US 2025/0159008 A1
(43) Pub. Date: May 15, 2025

(54) FULL-SCENE CYBERSECURITY THREAT-RELATED ANALYSIS METHOD AND SYSTEM THEREOF

(71) Applicants: Information and Communication Branch of State Grid Henan Electric Power Corporation, Zhengzhou (CN); State Grid Henan Electric Power Corporation, Zhengzhou (CN); Beijing University of Posts and Telecommunications, Beijing (CN)

(72) Inventors: Fangfang Dang, Zhengzhou (CN); Lijing Yan, Zhengzhou (CN); Shuai Li, Zhengzhou (CN); Shaoyong Guo, Zhengzhou (CN); Ying Yang, Zhengzhou (CN); Dingding Li, Zhengzhou (CN); Hao Wang, Zhengzhou (CN); Qidi Jiao, Zhengzhou (CN); Zhiying Wang, Zhengzhou (CN)

(21) Appl. No.: 18/942,758

(22) Filed: Nov. 10, 2024

(30) Foreign Application Priority Data
Nov. 10, 2023 (CN) 202311496634.6

(51) Int. Cl. H04L 9/40

(52) U.S. Cl. CPC H04L 63/1425; H04L 63/1416; H04L 63/1433

(57) ABSTRACT

A full-scene cybersecurity threat-related analysis method and a system thereof include: obtaining cybersecurity-related data, wherein the cybersecurity-related data includes network flow values at a plurality of predetermined time points within a predetermined time length and a network log of the predetermined time length; extracting a network flow chronological feature of the network flow values at the plurality of predetermined time points; extracting a log semantics feature of the network log; fusing the network flow chronological feature and the log semantics feature to obtain a network flow-log semantics cross-fusion feature; and determining a mode of attacker's behaviors based on the network flow-log semantics cross-fusion feature. Thus, it is possible to intelligently identify a mode of attacker's behaviors and detect a potential threat in the network.

### CROSS REFERENCE TO RELATED APPLICATIONS

The present application claims the benefit of Chinese Patent Application No. 202311496634.6 filed on Nov. 10, 2023, the contents of which are incorporated herein by reference in their entirety.

### FIELD OF THE INVENTION

The present invention relates to the technical field of intelligentization cybersecurity, more specifically, to a full-scene cybersecurity threat-related analysis method and a system thereof.

### BACKGROUND OF THE INVENTION

As cybersecurity threats rise increasingly, traditional single-source analysis methods can no longer meet requirements of accurate identification and classification to threats in complex network environments.

Therefore, people expect an optimized full-scene cybersecurity threat-related analysis method.

### SUMMARY OF THE INVENTION

In order to solve the above-mentioned technical problem, we propose the present invention. The embodiments of the present invention provide a full-scene cybersecurity threat-related analysis method and a system thereof, including the steps of: obtaining cybersecurity-related data, wherein the cybersecurity-related data includes network flow values at a plurality of predetermined time points within a predetermined time length and a network log of the predetermined time length; extracting a network flow chronological feature of the network flow values at the plurality of predetermined time points; extracting a log semantics feature of the network log; fusing the network flow chronological feature and the log semantics feature to obtain a network flow-log semantics cross-fusion feature; and determining a mode of attacker's behaviors based on the network flow-log semantics cross-fusion feature. Thus, it is possible to intelligently identify a mode of attacker's behaviors and detect a potential threat in the network.

As a first aspect of the present invention, we propose a full-scene cybersecurity threat-related analysis method, including the steps of:
obtaining cybersecurity-related data, wherein the cybersecurity-related data includes network flow values at a plurality of predetermined time points within a predetermined time length and a network log of the predetermined time length;
extracting a network flow chronological feature of the network flow values at the plurality of predetermined time points;
extracting a log semantics feature of the network log;
fusing the network flow chronological feature and the log semantics feature to obtain a network flow-log semantics cross-fusion feature; and
determining a mode of attacker's behaviors based on the network flow-log semantics cross-fusion feature.

As a second aspect of the present invention, we propose a full-scene cybersecurity threat-related analysis system, including:
a cybersecurity-related data obtaining module used to obtain cybersecurity-related data, wherein the cybersecurity-related data includes network flow values at a plurality of predetermined time points within a predetermined time length and a network log of the predetermined time length;
a network flow chronological feature extracting module used to extract a network flow chronological feature of the network flow values at the plurality of predetermined time points;
a log semantics feature extracting module used to extract a log semantics feature of the network log;
a feature fusing module used to fuse the network flow chronological feature and the log semantics feature, so as to obtain a network flow-log semantics cross-fusion feature; and
an attacker's behavior mode determining module used to determine a mode of attacker's behaviors based on the network flow-log semantics cross-fusion feature.

### BRIEF DESCRIPTION OF THE DRAWINGS

In order to more clearly explain the technical solutions of the embodiments of the present invention, we shall briefly describe the figures necessary to illustrate the examples or the prior as follows, and it is obvious that the figures in the following description only represent some embodiments of the present invention, so a person skilled in the art can also obtain other figures according to these figures without doing creative work.

FIG. 1 is a flowchart of the full-scene cybersecurity threat-related analysis method according to the embodiments of the present invention.

FIG. 2 is a structural diagram of the full-scene cybersecurity threat-related analysis method according to the embodiments of the present invention.

FIG. 3 is a block diagram of the full-scene cybersecurity threat-related analysis system according to the embodiments of the present invention.

FIG. 4 is a scene diagram of the full-scene cybersecurity threat-related analysis method according to the embodiments of the present invention.

### DETAILED DESCRIPTION OF SOME EMBODIMENTS

We shall describe the technical solutions within the embodiments of the present invention in combination with the figures within the examples of the present invention, and it is obvious that the described examples are some of the embodiments of the present invention, not all the embodiments. Based on the examples in the present invention, all other examples obtained by a person skilled in the art without doing creative work fall within the protection scope of the present invention.

Unless otherwise indicated, all technical and scientific terms used in the embodiments of the present invention have the same meanings as generally understood by a person skilled in the art. The terms used in the present invention are intended only to describe specific examples, not to pose any limitation on the present invention.

For the embodiments of the present invention, it should be noted that, unless otherwise specified or limited, the term “connection” shall be understood in a broad sense, for example, it may be an electrical connection, or an inherent connection between two elements, or a direct connection, or an indirect connection through an intermediate medium; therefore, the specific meaning of the above terms can be grasped by a person skilled in the art according to specific circumstances.

It should be noted that the terms “first/second/third” involved in the embodiments of the present invention are only to distinguish similar objects, not represent a specific sequence taken to the objects; therefore, it is understandable that the “first/second/third” can be replaced with each other into a specific sequence or a priority order in allowable circumstances. It should be understood that the objects distinguished according to the “first/second/third” are interchangeable in appropriate circumstances, so that the embodiments of the present invention described herein can be implemented in a sequence besides that illustrated or described herein.

Cybersecurity refers to a series of measures and technologies that protect computer systems, networks, and data from unauthorized access, use, disclosure, destruction, or interference. As the Internet has been popularized and information technology has been developed, the cybersecurity is becoming more and more important. The objective of cybersecurity is to ensure confidentiality (protecting data from being accessed by unauthorized persons), integrity (protecting data from tampering), availability (guaranteeing normal operation of systems and networks), and reliability (guaranteeing reliability of data and systems) of computer systems and networks.

Here are some common cybersecurity threats and countermeasures. The threat arises from hackers intruding into systems, stealing sensitive information, or destroying systems by all means; the countermeasure includes using strong passwords, regularly updating software and operating systems, and installing firewalls and intrusion detection systems. The threat arises from malware such as computer viruses, worms, Trojan horses, and spyware that can infect computer systems, causing data loss or system breakdown; the countermeasure includes installing anti-virus software, scanning the system regularly, and not opening attachments and links from unknown sources. The threat arises from spam and phishing emails that may contain fraudulent links and attachments used to defraud users of their personal information; the countermeasure includes not clicking on links in spam emails and not providing personal information to unknown sources. The threat arises from data breaches that may lead to the problems such as divulging individual privacy and trade secrets; the countermeasure includes encrypting sensitive data, restricting data access, and regularly backing up data. The threat arises from attackers obtaining information or access to systems by way of deceiving people and manipulating people's behavior; the countermeasure includes educating users to recognize social engineering attacks, stay vigilant, and not easily disclose personal information.

With continuous evolution and increase of cybersecurity threats, traditional single-source analysis methods can no longer meet requirements of accurate identification and classification to threats in complex cyber environments. Therefore, modern cybersecurity analysis and threat identification tend to employ multi-source data and comprehensive analysis methods.

Here are some of the key techniques and methods for modern cybersecurity analysis and threat identification. The traditional cybersecurity analysis mainly depends on single-data sources, such as log files or network flow data. The modern cybersecurity analysis tends to collect information from multiple data sources, such as network flow data, system logs, terminal device data, intrusion detection systems (IDS) and intrusion prevention systems (IPS), and the comprehensive analysis of multi-source data can provide more comprehensive threat information and more accurate threat identification.

With development of big data technology, a big data analysis method has also begun to be applied in the field of cybersecurity. The big data analysis can process large-scale network data, and discover hidden threat modes and abnormal behaviors by mining and analyzing massive data, and the big data analysis technology can help cybersecurity personnel better understand and respond to complex network threats. Machine learning and artificial intelligence technologies play an important role in the field of cybersecurity, and these technologies can automatically identify and classify threats by learning from historical data and identifying modes. For example, a machine learning-based intrusion detection system can learn normal network flow modes and detect anomalous behavior and potential attacks.

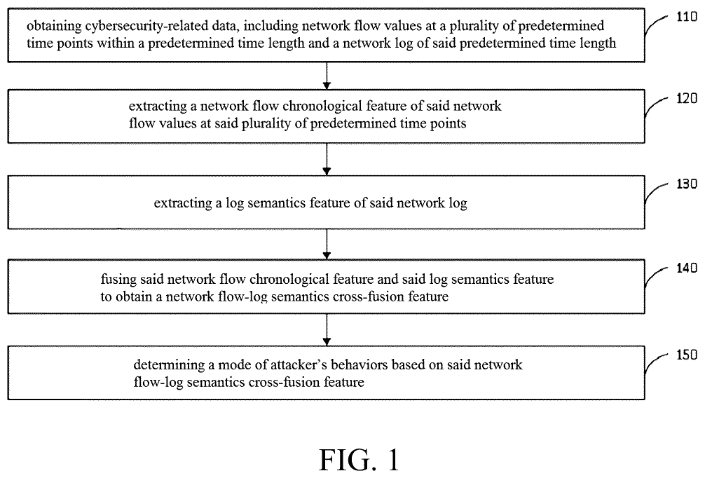

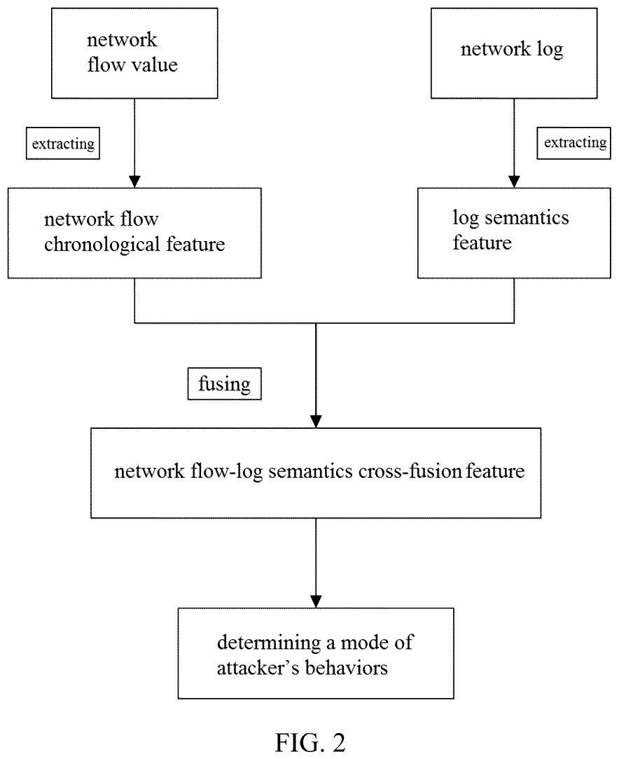

FIG. 1 is a flowchart of the full-scene cybersecurity threat-related analysis method according to the embodiments of the present invention. FIG. 2 is a structural diagram of the full-scene cybersecurity threat-related analysis method according to the embodiments of the present invention. As shown in FIGS. 1-2, the full-scene cybersecurity threat-related analysis method includes the steps of: 110 obtaining cybersecurity-related data, wherein the cybersecurity-related data includes network flow values at a plurality of predetermined time points within a predetermined time length and a network log of the predetermined time length; 120 extracting a network flow chronological feature of the network flow values at the plurality of predetermined time points; 130 extracting a log semantics feature of the network log; 140 fusing the network flow chronological feature and the log semantics feature to obtain a network flow-log semantics cross-fusion feature; and 150 determining a mode of attacker's behaviors based on the network flow-log semantics cross-fusion feature.

In the step of 110 obtaining cybersecurity-related data, it is necessary to ensure accurate and complete cybersecurity-related data, including the network flow values at the plurality of predetermined time points within the predetermined time length and the network log data and ensure reliability of data resources, and integrity and timeliness of data. Wherein, it is possible to provide a more comprehensive information basis, and a more reliable condition for subsequent analysis and identification by obtaining accurate and complete cybersecurity-related data.

In the step of 120 extracting network flow chronological features, it is necessary to extract meaningful chronological features from the network flow value within the predetermined time length, which possibly include a size, a direction, a duration and a frequency of the network flow, and take into account the dynamics and changes of the network flow at the time of selecting an appropriate feature-extracting method. In this way, it is possible to capture a changing mode and a trend of the network flow and provide richer information for subsequent analysis and identification by extracting a network flow chronological feature.

In the step of 130 extracting a log semantics feature, it is necessary to extract meaningful log semantics features from the network log data, which possibly include a keyword, an event type and an operation behavior in a log, and take into account the structure and content of the log data at the time of selecting an appropriate feature extracting method. Wherein, it is possible to assist in understanding events and behaviors that occur in the network and provide a deeper understanding for subsequent analysis and identification by extracting a log semantics feature.

In the step of 140 fusing the network flow chronological feature and the log semantics feature, it is necessary to ensure correlation and consistency between features by choosing an appropriate fusion method and algorithm at the time of fusing the network flow chronological feature and the log semantics feature to obtain the network flow-log semantics cross-fusion feature. In this way, it is possible to synthetically make use of information from different data sources and enhance the accuracy and efficiency of identifying potential threats in the network by fusing the network flow chronological feature and the log semantics feature.

In the step of 150 determining a mode of attacker's behaviors, it is possible to determine a mode of attackers' behaviors, select an appropriate algorithm and model, conduct model training and evaluation, and take into account the requirements of real-time and scalability by adopting a deep learning algorithm or other machine learning methods based on the network flow-log semantics cross-fusion feature. It is possible to timely detect and respond to potential threats in the network, and improve the defense capability and response speed for cybersecurity accidents by determining a mode of attacker's behaviors.

It is possible to enable intelligent identification to the mode of attackers' behaviors, so as to effectively detect potential threats in the network by obtaining the cybersecurity-related data, extracting the network flow and the log feature, and analyzing and identifying them in combination with the deep learning algorithm. This approach can improve the accuracy and efficiency of cybersecurity, assist in conducting and timely responding to cybersecurity threats.

In view of the above-mentioned technical problems, the technical conception provided by the present invention consists in using a network flow value and network log data in a predetermined time length, and performing feature extraction and feature association on the two in combination with a deep learning algorithm, so as to intelligently identify a mode of attacker's behaviors and detect a potential threat in the network.

The deep learning algorithm has advantages in processing large-scale data and complex mode recognition, and the deep learning model can learn modes of attackers' behaviors and accurately detect potential threats by way of performing feature extraction and correlation analysis on the network flow value and the network log data. The deep learning model can process large amounts of data in real-time and are able to analyze and make decisions in a short time, allowing a cybersecurity team to timely monitor threats in the network and take a rapid response measure to reduce potential losses. It is possible to enable an automated and intelligent process and learn and adapt to changing attack modes, so as to reduce dependence on human intervention by using the deep learning algorithm to detect threats, thus raising efficiency and decreasing false alarm rates. The deep learning model has a powerful generalization ability to discover previously-unknown threats and attack modes. Traditional rules and signature-based approaches may be unable to capture new types of attacks, and the deep learning model can detect these unknown threats by learning the features and modes of the data.

Based on this, in the technical solution of the present invention, it is necessary to obtain cybersecurity-related data, wherein the cybersecurity-related data includes network flow values at a plurality of predetermined time points within a predetermined time length and a network log of the predetermined time length. A person skilled in the art should know that the network flow values and the network logs are an important data source for performing correlation analysis on cybersecurity threats, as they can reflect anomalous behaviors in the network and attackers' intent. The network flow values can show changes in flow in the network, such as a sudden increase or decrease, which may be a sign that an attacker is taking actions such as scanning, probing, transmitting, or denial of service. The network logs can record various events in the network, such as logins, accesses, modifications, or deletions, which may be evidence that an attacker is taking actions such as infiltration, elevation of privilege, lateral movement, or data breaches. Therefore, in the technical solution of the present invention, it is expected that the network flow-log semantics cross-fusion feature will be used to perform a function in identifying modes of attackers' behaviors.

Then, extracting a network flow chronological feature of the network flow values at the plurality of predetermined time points. That is, to capture network flow dynamic change features contained in the network flow values chronologically discretely distributed, so as to reflect attackers' behaviors.

In an example of the present invention, the step of extracting a network flow chronological feature of the network flow values at the plurality of predetermined time points includes the sub-steps of: performing data preprocessing on the network flow values at the plurality of predetermined time points to obtain a network flow partial chronological input vector sequence; obtaining a network flow partial chronological feature vector sequence from the network flow partial chronological input vector sequence through a chronological feature extractor based on an one-dimensional convolutional layer; and taking the network flow partial chronological feature vector sequence as the network flow chronological feature.

In an example of the present invention, the sub-step of performing data preprocessing on the network flow values at the plurality of predetermined time points to obtain a network flow partial chronological input vector sequence includes: arranging the network flow values at the plurality of predetermined time points into a network flow partial chronological input vector in line with a time dimension; and segmenting the network flow partial chronological input vector to obtain the network flow partial chronological input vector sequence.

That is, in an example of the present invention, an encoding process for extracting a network flow chronological feature of the network flow values at the plurality of predetermined time points includes: firstly arranging the network flow values at the plurality of predetermined time points into a network flow partial chronological input vector in line with a time dimension; secondly segmenting the network flow partial chronological input vector to obtain a network flow partial chronological input vector sequence; thirdly obtaining a network flow partial chronological feature vector sequence from the network flow partial chronological input vector sequence through a chronological feature extractor based on an one-dimensional convolutional layer, as well as taking the network flow partial chronological feature vector sequence as the network flow chronological feature.

It is possible to retain chronological information of the network flows and assist in capturing a changing trend and mode of the network flows for subsequent feature extraction and analysis by arranging the network flows into a chronological input vector in line with a time dimension. Scattered data can be integrated by combining network flow values at multiple time points into a vector, which can simplify data processing and provide a more convenient form of data for subsequent feature extraction and model training.

It is possible to capture partial features in different time lengths and assist in analyzing and identifying partial modes of network flows, so as to enhance the accuracy of threat detection, by segmenting the chronological input vector into a partial chronological input vector sequence. Segmenting the chronological input vector can increase the diversity of data samples and assist in increasing the number and diversity of training data, and improving the generalization ability and robustness of the model.

It is possible to extract meaningful features from the partial chronological input vector, which can include partial modes, trends, and anomalous behaviors and assist in distinguishing between a normal network flow and a potential attack behavior, by using a chronological feature extractor based on a one-dimensional convolutional layer. The feature extractor can convert a high-dimensional partial chronological input vector into a low-dimensional chronological feature vector, which helps to reduce data dimensions, simplify the calculation and storage requirements of the model, and improve the efficiency and performance of the model.

It is possible to retain chronological information, extract partial features, and reduce data dimensions, so as to provide beneficial effects for subsequent network flow analysis and threat identification by the way of converting a network flow value into a chronological input vector, segmenting the vector, and extracting chronological features based on the one-dimensional convolutional layer.

Then, semantically encoding the network log to obtain a network log semantics feature vector sequence. That is, capturing a semantics feature of the network log, and understanding and analyzing various events recorded in the network log.

In an example of the present invention, the step of extracting a log semantics feature of the network log includes: semantically encoding the network log to obtain a network log semantics feature vector sequence, and taking the network log semantics feature vector sequence as the log semantics feature.

Further, in an example of the present invention, the step of fusing the network flow chronological feature and the log semantics feature to obtain a network flow-log semantics cross-fusion feature includes the sub-steps of obtaining a network flow-log semantics cross-fusion feature vector from the network flow partial chronological feature vector sequence and the network log semantics feature vector sequence through an associative fusion module based on gate attention mechanism; and taking the network flow-log semantics cross-fusion feature vector as the network flow-log semantics cross-fusion feature.

In the sub-step of obtaining a network flow-log semantics cross-fusion feature vector from the network flow partial chronological feature vector sequence and the network log semantics feature vector sequence through an associative fusion module based on gate attention mechanism, it is helpful to associate information from different data sources to capture correlations and interaction modes between the network flow and the log by associating the network flow partial chronological feature vector and the network log semantics feature vector through the associative fusion module. Association and fusion enable the feature information of network flows and logs to be supplemented and enriched with each other. The network flows provide chronological information about network behaviors, while the network logs provide information about events and behavioral semantics. The cross-fusion features enable the information from both to be synthetically used, so as to improve the ability to identify potential threats in the network.

In the sub-step of taking the network flow-log semantics cross-fusion feature vector as the network flow-log semantics cross-fusion feature, the network flow-log semantics cross-fusion feature vector synthesizes the information of network flows and logs, provides a more comprehensive feature representation, which helps to describe the behaviors and events in the network more accurately, thereby improving the accuracy of threat identification. It is possible to reduce original data dimensions to a vector of a fixed dimension, which helps to simplify the calculation and storage requirements of the model and improves the efficiency and performance of the model by taking the network flow-log semantics cross-fusion feature vector as a final feature representation.

It is possible to realize information association and enrichment to different data sources, and improve comprehensiveness and accuracy of features by fusing the network flow partial chronological feature vector and the network log semantics feature vector through an associative fusion module based on gate attention mechanism. Using the fusion feature vector as the final feature representation can provide a more comprehensive feature description, which can provide a beneficial effect for subsequent threat identification and analysis.

In an example of the present invention, the step of determining a mode of attacker's behaviors based on the network flow-log semantics cross-fusion feature includes: performing feature distribution modification on the network flow-log semantics cross-fusion feature vector to obtain a modified network flow-log semantics cross-fusion feature vector; and obtaining a classification result from the modified network flow-log semantics cross-fusion feature vector through a classifier, wherein the classification result is used to represent a mode label of attacker's behaviors.

The feature distribution modification can standardize the feature vectors to make them in line with a certain distribution characteristic, helping to eliminate a dimensional difference between features and make the influence of different features on the model more balanced. It is possible to reduce the influence of an anomalous values or an outlier in the feature vectors, and make the modified feature vector more stable through the feature distribution modification, helping to improve the robustness and generalization ability of the model. The feature distribution modification can make the distribution of feature vectors closer to the standard normal distribution or uniform distribution, helping to improve the convergence of the model, thus improving the training efficiency and convergence speed of the model. It is possible to adjust a distribution form of feature vectors through the feature distribution modification, so as to make it more in line with feature expression requirements of a task, and the modified feature vector can better capture an important feature of data and improve the expression ability of the model.

It is possible to improve the standardization and stability of features, improve the robustness and convergence of the model, and improve the expression ability of features, so as to help to improve the effect of threat identification and cybersecurity analysis and make the model more accurate and reliable, by the way of performing feature distribution modification on the network flow-log semantics cross-fusion feature vector.

Herein, the network flow partial chronological feature vector sequence and the network log semantics feature vector sequence respectively represent a chronological associative feature of the network flow value and a textual semantic feature of the network log; therefore; it is possible to fuse the network flow partial chronological feature vector sequence and the network log semantics feature vector sequence by representing importance weights based on a cross-domain feature between the parameter chronological associative feature and the textual semantic feature through an associative fusion module based on gate attention mechanism, thus paying more attention to the partial distribution more correlated to each other in the feature distribution of the chronological associative feature of the network flow value and the textual semantic feature of the network log, and making the network flow-log semantics cross-fusion feature vector further express related associative feature distribution between the two beyond the expression of the parameter chronological associative feature and the textual semantic feature. However, in this way, the network flow-log semantics cross-fusion feature vectors are discrete in feature distribution under the chronological association domain—semantic space domain having parameter features and text features; therefore, it is necessary to improve efficiency of categorical regression due to discreteness in cross-domain feature distribution having heterogeneous features at the time of performing categorical regression through a classifier.

Therefore, at the time of performing categorical regression on the network flow-log semantics cross-fusion feature vectors through a classifier, the applicant will optimize the network flow-log semantics cross-fusion feature vectors. Specifically, the following optimization formula is used to optimize the network flow-log semantics cross-fusion feature vectors to obtain modified network flow-log semantics cross-fusion feature vectors. The optimization formula is as follows.

$${v}_{i}^{′} = exp [ 2 ( \sqrt{1 + \frac{{v}_{i}}{\overline{v}}} - 1 ) ] - [ 2 ( \sqrt{1 + \frac{\overline{v}}{{v}_{max}}} - 1 ) ]$$

Where, vᵢ represents a feature value at the i^{th} position within the network flow-log semantics cross-fusion feature vector, V represents a population mean of all feature values of the network flow-log semantics cross-fusion feature vector, vₘₐₓ represents a maximum feature value of the network flow-log semantics cross-fusion feature vector, vᵢ′ represents a feature value at the i^{th} position within the modified network flow-log semantics cross-fusion feature vector, exp(·) represents a value of a natural exponential function that calculates the power of a numeric value.

That is, with the aid of the concept of the regularization imitation function of the globally distributed feature parameters of the network flow-log semantics cross-fusion feature vector, the above optimization is represented in the form of parameter vectors on the basis of the global distribution of the network flow-log semantics cross-fusion feature vectors, so as to express a simulation cost function by the regular expression of regression probability; in this way, modelling the feature manifold representation of the network flow-log semantics cross-fusion feature vectors within a high-dimensional feature space with respect to point-by-point regression characteristics of a classifier-based weight matrix under categorical regression probability, so as to capture a parameter smoothing optimization trajectory of the network flow-log semantics cross-fusion feature vectors to be classified under a scene geometry of high-dimensional feature manifold via a parameter space of a classifier model, and improve the training efficiency of the network flow-log semantics cross-fusion feature vector under the classification probability regression of the classifier.

Then, obtaining a classification result from the modified network flow-log semantics cross-fusion feature vector through a classifier, wherein the classification result is used to represent a mode label of attacker's behaviors. It is possible to determine whether the features of the network flow and the network log belong to a mode of attackers' behaviors by using the classifier to classify the modified network flow-log semantics cross-fusion feature vectors, so as to help to monitor potential threats in the network in real time and timely take corresponding defensive measures. It is possible to achieve automatically detecting threats and generating behavior mode labels by using the classifier to classify the modified network flow-log semantics cross-fusion feature vectors, so as to reduce the burden of manual analysis, improve the efficiency of threat detection, and intelligently identify and classify different types of modes of attackers' behaviors. It is possible to identify a known mode of attackers' behaviors, and detect an unknown and new threat behavior by using the classifier to classify the modified network flow-log semantics cross-fusion feature vectors, so as to help to timely discover and respond to a new cybersecurity threat and improve the security and defense capability.

It is possible to achieve highly-accurately detecting threats and generating a mode label of attackers' behaviors by using the classifier to classify the modified network flow-log semantics cross-fusion feature vectors; thus, this method has beneficial effects such as automation, intelligence, and ability to discover an unknown threat, helping to improve the effectiveness of cybersecurity and defense capability.

In summary, we have explained the full-scene cybersecurity threat-related analysis method according to the embodiments of the present invention that consists in using a network flow value and network log data in a predetermined time length, and perform feature extraction and feature association on the two in combination with a deep learning algorithm, so as to intelligently identify a mode of attacker's behaviors and detect a potential threat in the network.

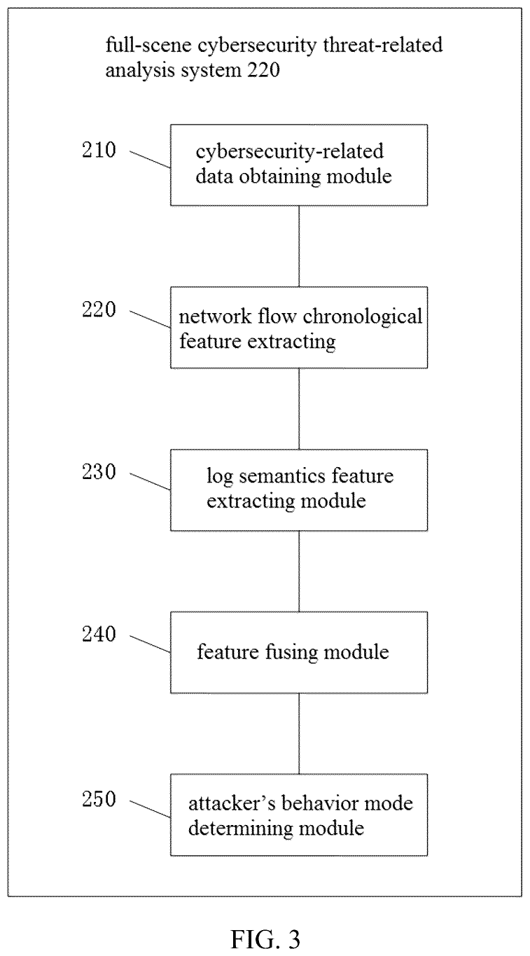

In an example of the present invention, FIG. 3 is a block diagram of the full-scene cybersecurity threat-related analysis system according to the embodiments of the present invention. As shown in FIG. 3, the full-scene cybersecurity threat-related analysis system 200 according to the embodiments of the present invention includes: a cybersecurity-related data obtaining module 210 used to obtain cybersecurity-related data, wherein the cybersecurity-related data includes network flow values at a plurality of predetermined time points within a predetermined time length and a network log of the predetermined time length; a network flow chronological feature extracting module 220 used to extract a network flow chronological feature of the network flow values at the plurality of predetermined time points; a log semantics feature extracting module 230 used to extract a log semantics feature of the network log; a feature fusing module 240 used to fuse the network flow chronological feature and the log semantics feature, so as to obtain a network flow-log semantics cross-fusion feature; and an attacker's behavior mode determining module 250 used to determine a mode of attacker's behaviors based on the network flow-log semantics cross-fusion feature.

In the full-scene cybersecurity threat-related analysis system, the network flow chronological feature extracting module includes a data preprocessing unit used to perform data preprocessing on the network flow values at the plurality of predetermined time points to obtain a network flow partial chronological input vector sequence; a chronological feature extracting unit used to obtain a network flow partial chronological feature vector sequence from the network flow partial chronological input vector sequence through a chronological feature extractor based on an one-dimensional convolutional layer; and a network flow chronological feature generating unit used to take the network flow partial chronological feature vector sequence as the network flow chronological feature.

In the full-scene cybersecurity threat-related analysis system, the data preprocessing unit includes a vector arranging subunit used to arrange the network flow values at the plurality of predetermined time points into a network flow partial chronological input vector in line with a time dimension; and a vector segmenting subunit used to segment the network flow partial chronological input vector to obtain the network flow partial chronological input vector sequence.

Herein, a person skilled in the art can understand that the specific functions and operations of each unit and module in the above-mentioned full-scene cybersecurity threat-related analysis system have been described in detail in the description of the full-scene cybersecurity threat-related analysis method with reference to FIGS. 1-2 above; therefore, it is possible to omit repeating its description.

As mentioned above, the full-scene cybersecurity threat-related analysis system 200 according to the embodiments of the present invention may be applied in various terminal devices, such as servers used for full-scene cybersecurity threat-related analysis. In an example, the full-scene cybersecurity threat-related analysis system 200 according to the embodiments of the present invention may be integrated into a terminal device as a software module and/or hardware module. For example, the full-scene cybersecurity threat-related analysis system 200 may be a software module in the operating system of the terminal device, or an application program developed for the terminal device; of course, the full-scene cybersecurity threat-related analysis system 20 may also be one of the many hardware modules of the terminal device.

Alternatively, in another example, the full-scene cybersecurity threat-related analysis system 200 may also be separate from the terminal device, and the full-scene cybersecurity threat-related analysis system 200 can be connected to the terminal device through a wired network and/or wireless network, and transmit interactive information in accordance with an agreed data format.

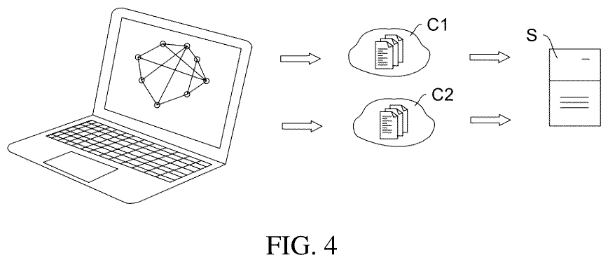

FIG. 4 is a scene diagram of the full-scene cybersecurity threat-related analysis method according to the embodiments of the present invention. As shown in FIG. 4, in this application scene, firstly obtain cybersecurity-related data, wherein the cybersecurity-related data includes network flow values at a plurality of predetermined time points within a predetermined time length (For example, C1 as shown in FIG. 4) and a network log of the predetermined time length (For example, C2 as shown in FIG. 4); then input the obtained network flow values and network logs into a server (For example, S as shown in FIG. 4) configured with a full-scene cybersecurity threat-related analysis algorithm, wherein the server can process the network flow values and the network logs based on an AI big data analysis algorithm to determine a mode of attacker's behaviors.

It should also be noted that in the means, devices and methods of the present invention, each component or step may be disassembled and/or recombined. Such disassembly and/or recombination shall be considered as an equivalent to the present invention.

The above description to the disclosed aspects enables a person skilled in the art to execute or apply the application. The various modifications to these aspects are very obvious to a person skilled in the art, and the general principles defined herein can be applied to other aspects without departing from the scope of the present application. Therefore, the present invention is not intended to pose any limitation on the aspects shown herein, but explained as the widest range consistent with the principles and novel features disclosed herein.

The above description has been given for the purposes of illustration and explanation. In addition, this description is not intended to restrict the embodiments of the present invention to the form disclosed herein. Although several exampled aspects and embodiments have been discussed above, a person skilled in the art will call to mind some of their variants, modifications, changes, additions, and sub-combinations.

What is claimed is:

1. A full-scene cybersecurity threat-related analysis method, comprising the steps of:
obtaining cybersecurity-related data, including network flow values at a plurality of predetermined time points within a predetermined time length and a network log of said predetermined time length;
extracting a network flow chronological feature of said network flow values at said plurality of predetermined time points;
extracting a log semantics feature of said network log;
fusing said network flow chronological feature and said log semantics feature to obtain a network flow-log semantics cross-fusion feature; and
determining a mode of attacker's behaviors based on said network flow-log semantics cross-fusion feature.

2. The full-scene cybersecurity threat-related analysis method according to claim 1, wherein the step of extracting a network flow chronological feature of said network flow values at said plurality of predetermined time points includes the sub-steps of:
performing data preprocessing on said network flow values at said plurality of predetermined time points to obtain a network flow partial chronological input vector sequence;
obtaining a network flow partial chronological feature vector sequence from said network flow partial chronological input vector sequence through a chronological feature extractor based on a one-dimensional convolutional layer; and
taking said network flow partial chronological feature vector sequence as said network flow chronological feature.

3. The full-scene cybersecurity threat-related analysis method according to claim 2, wherein the sub-step of performing data preprocessing on said network flow values at said plurality of predetermined time points to obtain a network flow partial chronological input vector sequence includes:
arranging said network flow values at said plurality of predetermined time points into a network flow partial chronological input vector in line with a time dimension; and
segmenting said network flow partial chronological input vector to obtain said network flow partial chronological input vector sequence.

4. The full-scene cybersecurity threat-related analysis method according to claim 3, wherein the step of extracting a log semantics feature of said network log includes:
semantically encoding said network log to obtain a network log semantics feature vector sequence, and
taking said network log semantics feature vector sequence as said log semantics feature.

5. The full-scene cybersecurity threat-related analysis method according to claim 4, wherein the step of fusing said network flow chronological feature and said log semantics feature to obtain a network flow-log semantics cross-fusion feature includes the sub-steps of:
obtaining a network flow-log semantics cross-fusion feature vector from said network flow partial chronological feature vector sequence and said network log semantics feature vector sequence through an associative fusion module based on gate attention mechanism; and
taking said network flow-log semantics cross-fusion feature vector as said network flow-log semantics cross-fusion feature.

6. The full-scene cybersecurity threat-related analysis method according to claim 5, wherein the sub-step of obtaining a network flow-log semantics cross-fusion feature vector from said network flow partial chronological feature vector sequence and said network log semantics feature vector sequence through an associative fusion module based on gate attention mechanism includes:
calculating an importance level representation vector between said network flow partial chronological feature vector sequence and said network log semantics feature vector sequence according to a following importance level representation formula,
$${S}_{i} = σ ( A * {ω}_{i} + B * \frac{1}{N} {\sum }_{i = 1}^{N} {h}_{i}$$
where, A represents a matrix of 1×N_{ω}, B represents a matrix of 1×Nₕ, a represents a sigmoid function, ωᵢ represents the i^{th} network flow partial chronological feature vector within said network flow partial chronological feature vector sequence, hᵢ represents the i^{th} network log semantics feature vector within said network log semantics feature vector sequence, N represents a number of the vectors within said network log semantics feature vector sequence, Sᵢ represents a feature value at the i^{th} position within said importance level representation vector; and
taking each feature value of said importance level representation vector as a weight to dynamically update each network flow partial chronological feature vector within said network flow partial chronological feature vector sequence, so as to obtain said network flow-log semantics cross-fusion feature vector.

7. The full-scene cybersecurity threat-related analysis method according to claim 6, wherein the step of determining a mode of attacker's behaviors based on said network flow-log semantics cross-fusion feature includes:
performing feature distribution modification on said network flow-log semantics cross-fusion feature vector to obtain a modified network flow-log semantics cross-fusion feature vector; and
obtaining a classification result from said modified network flow-log semantics cross-fusion feature vector through a classifier, wherein said classification result is used to represent a mode label of attacker's behaviors.

8. A full-scene cybersecurity threat-related analysis system, comprising:
a cybersecurity-related data obtaining module used to obtain cybersecurity-related data, wherein the cybersecurity-related data includes network flow values at a plurality of predetermined time points within a predetermined time length and a network log of the predetermined time length;
a network flow chronological feature extracting module used to extract a network flow chronological feature of said network flow values at said plurality of predetermined time points;
a log semantics feature extracting module used to extract a log semantics feature of said network log;
a feature fusing module used to fuse said network flow chronological feature and said log semantics feature, so as to obtain a network flow-log semantics cross-fusion feature; and
an attacker's behavior mode determining module used to determine a mode of attacker's behaviors based on said network flow-log semantics cross-fusion feature.

9. The full-scene cybersecurity threat-related analysis system according to claim 8, wherein said network flow chronological feature extracting module includes:
a data preprocessing unit used to perform data preprocessing on said network flow values at said plurality of predetermined time points to obtain a network flow partial chronological input vector sequence;
a chronological feature extracting unit used to obtain a network flow partial chronological feature vector sequence from said network flow partial chronological input vector sequence through a chronological feature extractor based on a one-dimensional convolutional layer; and
a network flow chronological feature generating unit used to take said network flow partial chronological feature vector sequence as said network flow chronological feature.

10. The full-scene cybersecurity threat-related analysis system according to claim 9, wherein said data preprocessing unit includes:
a vector arranging subunit used to arrange said network flow values at said plurality of predetermined time points into a network flow partial chronological input vector in line with a time dimension; and
a vector segmenting subunit used to segment said network flow partial chronological input vector to obtain said network flow partial chronological input vector sequence.
